(19) United States
(12) Patent Application Publication
(10) Pub. No.: US 2008/0078616 A1
(43) Pub. Date: Apr. 3, 2008

(54) Self leveling ladder system

(76) Inventor: Mark A. Ursitti, Ft. Myers, FL (US)

Correspondence Address: Mark A. Ursitti, 15400 Will Lew Lane, Ft. Myers, FL, 33908, US

(21) Appl. No.: 11/542,017

(22) Filed: Oct. 3, 2006

(51) Int. Cl. E06C 1/00

(52) U.S. Cl. 182/201; 182/200

(57) ABSTRACT

A self-leveling ladder system constituting both a straight or a step ladder system which includes hydraulic cylinders which are attached to the bottom of each of the ladder frames. The hydraulic cylinders are interconnected by hydraulic pressure lines and filled with a hydraulic fluid. The hydraulic pressure lines each include an off and on valve. In an on position of the valve, the hydraulic fluid freely flows through the pressure lines and the hydraulic cylinders. When the ladder, straight or step, is placed on an uneven ground and the foot pads on the bottom of the ladder have reached their proper position with respect to a vertical position of the ladder, the ladder will attain a stable position when the valve is placed into an off position.

### BACKGROUND OF THE INVENTION

Ladders, especially stepladders, are known wherein the surface below the ladder exhibits an uneven ground. This is especially true in an outdoor environment where landscapers must move ladders from one particular location to another. Those locations may be right next to each other. For example, when cutting or trimming the top of a tall hedge, the ladder (a step ladder in this case) must be moved quickly from one location to the next operating position in order to be cost effective. Of course, the ladder at this new position encounters a different ground level at all four bottoms of the legs. There are many devices or systems that account for this repeated adjustment or the ladder would not be stable.

U.S. Pat. No. 5,913,382 shows a ladder extension system that involves a telescoping arrangement on each leg whereby the position of the each of the legs may be adjusted by push-pull pins that will lock into predetermined positions on each leg to accommodate different ground levels. However, this involves a manual operation and is not a self-leveling operation.

U.S. Pat. No. 5,678,656 illustrates a ladder leveling system that is operated by a foot operated step.

U.S. Pat. No. 5,464,071 shows a ladder leveling system that is operated by a hand crank operation which is not a self leveling system of the present invention.

U.S. Pat. No. 5,335,754 discloses a self-leveling ladder that has a pair of spaced apart side rails and a plurality of spaced apart rungs extending between the side rails. A pair of elongated sleeves slidably embrace the bottoms of the rails. This system involves a pawl and teeth arrangement. Once one of the spaced apart rails is lifted, the pawl and teeth arrangement will find its proper position to level the ladder at its safe level. However, once the pawl and teeth arrangement is set it cannot be reversed without a manual intervention.

U.S. Pat. Nos. 6,435,306; 6,450,292; 6,479,113 and 6,779,660 all show ladder level adjustments by various manual intervention means. None of the above identified patents do not teach or disclose or self-leveling device that will automatically adjust to a particular ground level with the intervention of a human hand.

### BRIEF DESCRIPTION OF THE INVENTION

The invention at hand does not need any human intervention wherever it is being used. The invention at hand involves hydraulic cylinders placed at each end or foot of a ladder. It can be a straight ladder having only two feet at its bottom or it can be a step ladder involving four feet. The hydraulic cylinder each include a piston which are movable within each cylinder. Any two cylinders on each leg are connected by way of a hydraulic line, tube or pipe. The cylinders and the lines are filled with a hydraulic fluid to its or their capacity. When a ladder as placed into its desired position, the cylinder shaft connected to bottom feet will find their bottom contact and rest thereat. A valve, when activated, will now prevent any hydraulic fluid to flow between the cylinders to thereby establish a firm position between the bottom feet and the ground, even if the difference between the ground level and the feet is quite different. Since no hydraulic fluid can now flow between the cylinders, a stable position is established for the ladder.

### DETAILED DESCRIPTION OF THE DRAWINGS

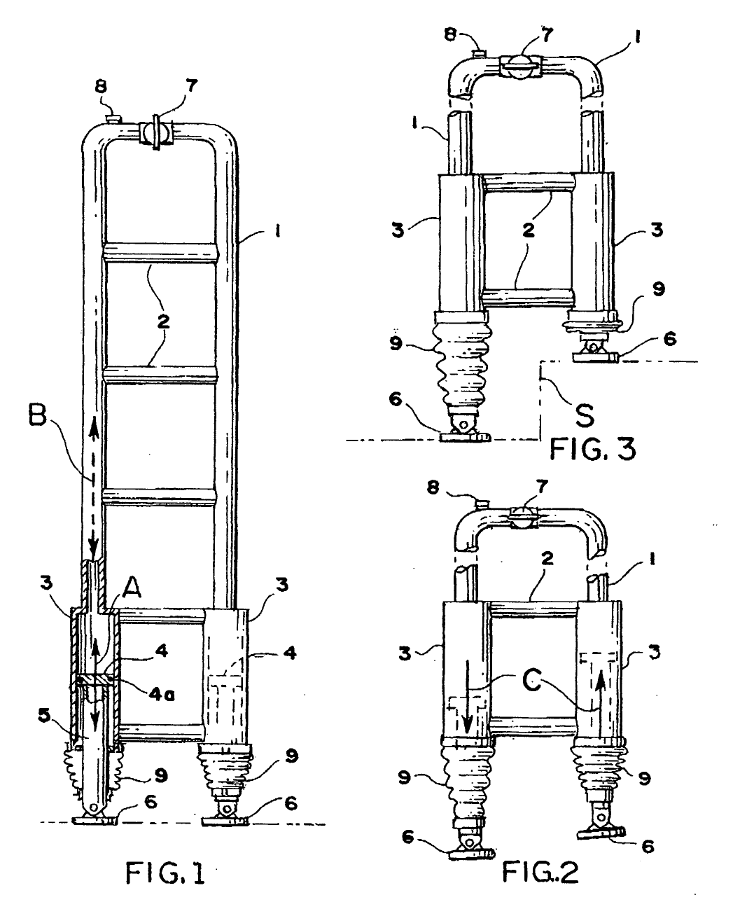

FIG. 1 is a front view of a ladder having tubular rails and hydraulic cylinders at the bottom of each of the rails;

FIG. 2 illustrates the foot sections being situated on different ground levels;

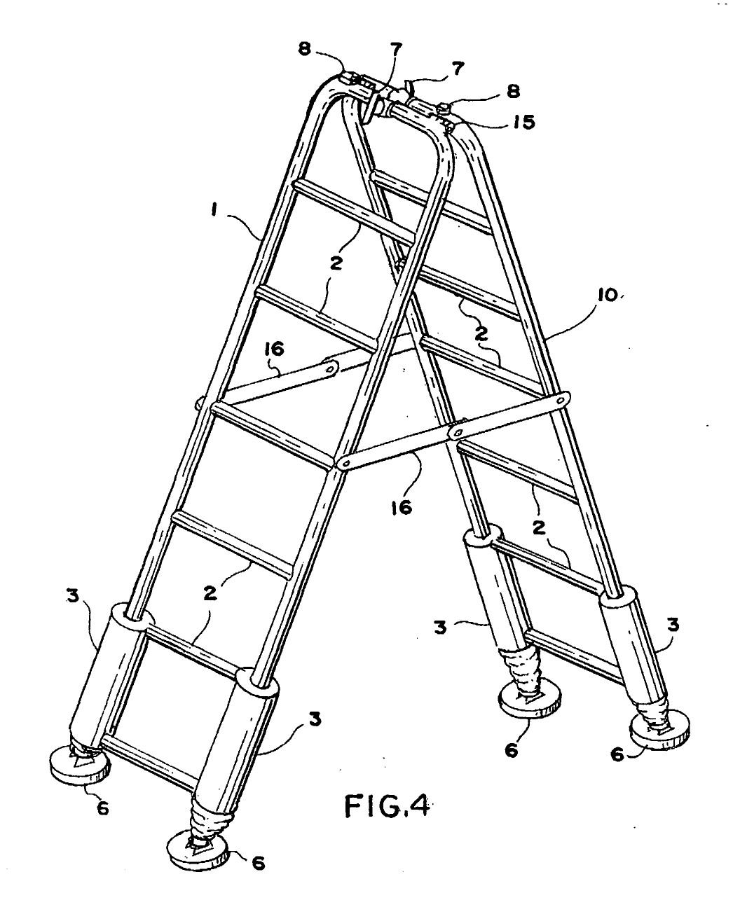

FIG. 3 illustrates a state whereby the foot sections are located on two different and elevated steps located horizontally from each other;

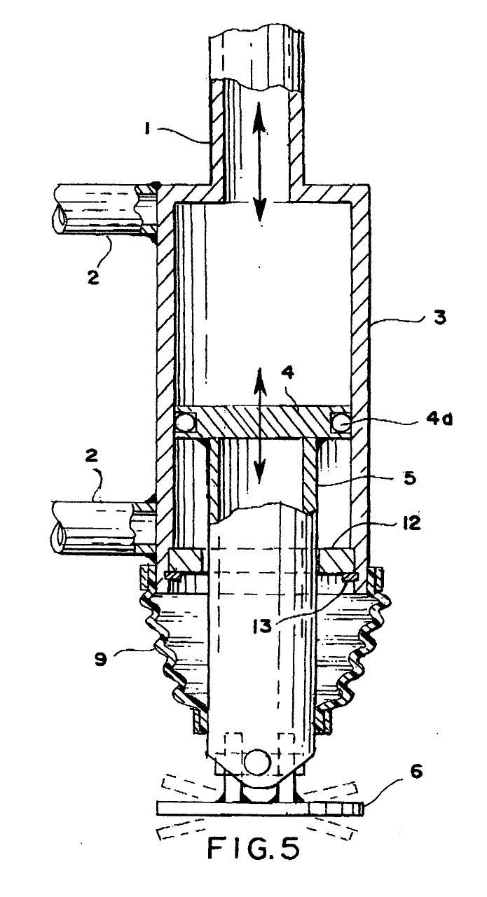

FIG. 4 Shows a step ladder having four individual foot section being individually adjustable from each other on different ground levels:

FIG. 5 discloses the individual structure of one of the hydraulic cylinders;

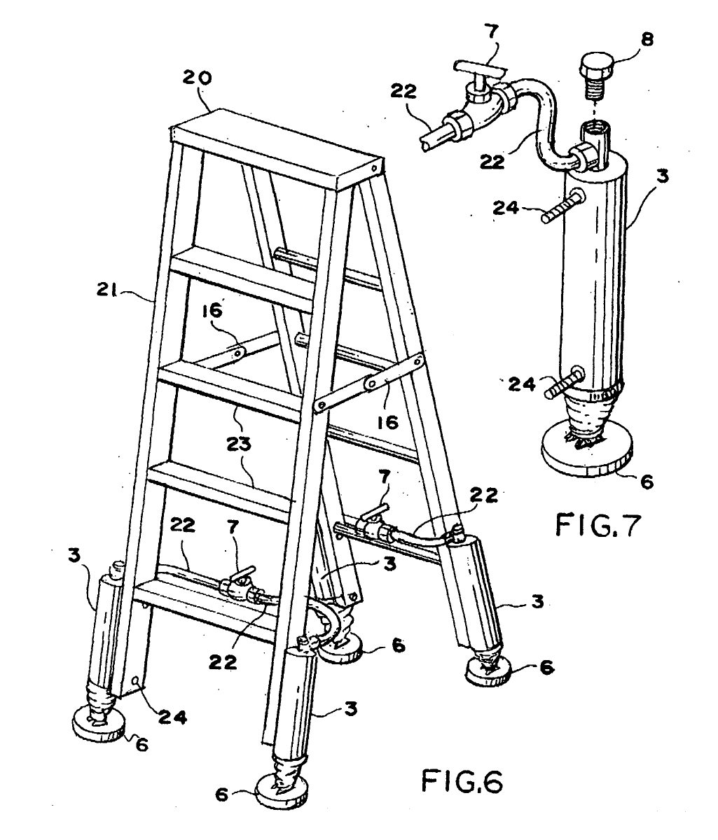

FIG. 6 shows four hydraulic cylinders in a retrofit location on a conventional step ladder;

FIG. 7 illustrates a hydraulic cylinder as a retrofit for conventional ladder.

### DETAILED DESCRIPTION OF THE INVENTION

FIG. 1 illustrates a ladder 1 having been made of cylindrical tubing. The ladder 1 has rails 1 which communicate with each other by virtue of being hollow and being welded to each other to obtain a hermetically sealed structure. The rails of the ladder have added thereto the rungs 2, which are also welded to the side rails 1. At the bottom of each side rail 1 there is each a hydraulic cylinder 3 which is each welded to the hollow side rails 1. Each cylinder has a piston 4 therein including an O-ring 4a. Arrow A indicates the direction of movement of the piston within the cylinder 3. Below the piston 4 there is attached a tubular rod 5 which continues down to swivel a swivel foot pad 6. The swivel of the foot pads 6 allows the foot pads to assume any position that is dictated by the level of the ground. Arrow B indicates the direction of the fluid within the hollow side rails 1 which must be same movement as arrow a because of the nature of the non compressible fluid being used in this ladder system. On top of the ladder and in its cross section there is located an off or on valve 7 which will close or open the fluid flow within the tubular frame work of the ladder including the cylinders 3. The numeral 8 indicates a bleed and filler cap which is used to either drain the fluid from the tubular construction of the ladder or to top off the fluid level within the tubular construction when necessary. The bottom of the cylinder, especially the pipe legs have attached thereto a dust cover 9 which may be useful since the foot swivel pads 6 may be scraped over the ground and may create dust or dirt.

FIG. 2 illustrates a condition of the ladder where two foot pads 6 are placed on uneven grounds. The same reference characters are being used to identify the same elements already discussed in FIG. 1.

FIG. 3 shows the same condition as was shown in FIG. 2 except that the foot pads 6 are placed on distinct foot steps identified as S.

FIG. 4 illustrates the ladder of FIGS. 1-3 but in a dual mode. In this presentation the ladder of FIGS. 1-3 is combined with a second ladder frame 10 to form a step ladder. At the top of each of the ladders 1 and 10 there is a hinge 15 which will enable a user to spread the two ladder at different angles which is well known in step ladders. The brace 16 will give stability to the step ladder once it is deployed. Of course, each of the ladder frames will have a an open or close valve on top of each cross section. This will enable a user to adjust the ladder system to a perfect vertical position even though the ground levels may be quite different from each leg location.

FIG. 5 shows a cross section through any of the cylinders used in any of the above embodiments. The same references have been used to identify the same elements. The piston a is shown as having an O-ring 4a installed therein to increase the piston's efficiency as is well known. At the bottom of the cylinder 3 and at the inside there is placed a guide ring 12 which will guide the pipe leg 5 through its proper and aligned movement. The guide ring 12 is held in place by a snap ring 13.

FIG. 6 illustrates the use of the cylinders 3 in a retrofit arrangement. FIG. 6 illustrates a conventional step ladder having the well known frames 21 and a top step 20.

The brace 16 controls the spread of the ladder legs with respect to each other. The rungs of the ladder are indicated at 23. A hydraulic cylinder 3 may be installed at the bottom of each of the legs of the step ladder. Once installed, the cylinders 3 may be connected be connected by a pressure tube 2 for the reason as was discussed with reference to FIGS. 1-4. Each of the pressure tubes may have connected thereto the on or off valve to stop or enhance the flow of the hydraulic fluid to aid in obtaining a proper vertical alignment of the step ladder. A stop position of the valve 7 will immediately stabilize the step ladder into its desired position.

FIG. 7 illustrates the piston 3 in a perspective view. Like numerals are being used as were used with regards to all previous Figs. At one side of the cylinder 3 there are attached by welding, or any way of fastening, bolts 24. To attach the cylinders 3 at the bottom of each of the legs of a ladder or a step ladder, it is merely up to the operator to drill holes in respective locations and then to fasten the cylinder 3 by way of a nut and bolt arrangement 24. The pressure tubes 22 and their respective on or off valves 7 may be fastened to one of the rungs 23. The operation of this retrofit system is the same as was explained with regard to previous Figs.

What I claim is:

1. A self-leveling ladder system including a first two sided ladder frame, said frame having at least two bottom ground contacting pads, A hydraulic cylinder is attached to a bottom of each of said two sided ladder frame, a hydraulic pressure conveyance is attached between each of said hydraulic cylinders, an off and on valve is connected into said hydraulic conveyance including a filler and bleed cap, whereby, when said off and on valve is an open position, hydraulic fluid will flow through said hydraulic pressure tube and into or out of said respective cylinders depending on where said contact pads make contact with an uneven ground, a closure of said off and on valve will stabilize said ladder in a desired vertical position.

2. The self-leveling ladder system of claim 1, wherein said hydraulic conveyance is the frame of said first two sided ladder frame constituting hollow frame members that are connected to said hydraulic cylinders.

3. The self-leveling ladder system of claim 1 including a second two-sided frame being attached to a said first frame member at a top thereof.

4. The self-leveling ladder system of claim 3 wherein said first and second frame members are attached to each other by way of a hinge to thereby form a step ladder.

5. The self-leveling ladder system of claim 4 wherein said second frame members have attached thereto and at a bottom thereof, each a hydraulic cylinder to be included in the self-leveling ladder system, whereby said step ladder will self-level all four bottom pads of said ladder system simultaneously.

6. The self-leveling ladder system of claim 1 including conventional step ladder frames, having four bottoms pads, a hydraulic cylinder is attached to each of the four bottom pads, a first hydraulic pressure line is connected between two cylinders on one of the ladders frames and a second hydraulic pressure line is attached between two cylinders of another of the ladder frames, an off and on valve is placed within each of said first and said second hydraulic pressure lines to obtain a substantial vertical position of said step ladder when said valves are in an off positions.

7. The self-leveling ladder system of claim 1, wherein said hydraulic cylinder has at least two threaded bolts attached to an outer surface thereof to be attached to each of said ladder frames at a bottom thereof by way of a nut and bolt arrangement.
